(19) United States
(12) Patent Application Publication
(10) Pub. No.: US 2016/0341654 A1
(43) Pub. Date: Nov. 24, 2016

(54) DARK FIELD FLOW CYTOMETRY IMAGING SYSTEM

(71) Applicant: Fluid Imaging Technologies, Inc., Scarborough, ME (US)

(72) Inventors: Christian K. Sieracki, Edgecomb, ME (US); Kent A. Peterson, Yarmouth, ME (US); Ilmars Labrencis, Sweden, ME (US)

(73) Assignee: FLUID IMAGING TECHNOLOGIES, INC., Scarborough, ME (US)

(21) Appl. No.: 14/715,689

(22) Filed: May 19, 2015

(51) Int. Cl. G01N 15/14

(52) U.S. Cl. CPC G01N 15/1436; G01N 15/1456; G01N 2015/1486

(57) ABSTRACT

An imaging flow cytometry system including dark field illumination to contrast particles in a flowing fluid. The system includes a condenser with blocking aperture and a numerical aperture of no less than 0.4. The system also includes a microscope objective for focusing dark field illuminated particles, wherein the objective has a numerical aperture of 0.3. The system further includes imaging optics, an image capturing system and a backlighting generator.

### FIELD OF THE INVENTION

The present invention relates generally to an optical flow imaging and analysis configuration used in particle analysis instrumentation, and more particularly to an optical flow imaging system and method incorporating the imaging technique referred to as dark field imaging in flow particle imaging. This combination provides effective contrast in illuminating particles thereby enabling more effective particle detection and identification than previously enabled.

### BACKGROUND OF THE INVENTION

Various optical/flow systems employed for transporting a fluid within an analytical instrument to an imaging and optical analysis area exist in the art. A liquid sample is typically delivered into the bore of a flow chamber and the sample is interrogated in some way so as to generate analytical information concerning the nature or properties of the sample. For example, a laser beam may excite the sample present in the bore of the flow cell, and the emitted fluorescence energy provides signal information about the nature of the sample. In other forms of such technology, a light source may be directed to the chamber to illuminate its contents. One or more photographs may be taken of the illuminated contents for the purpose of capturing one or more views of the contents of the fluid located in the photographic field.

In the context of particle detection analysis, it is desirable to bring to bear as much light as possible on images to be detected without introducing so much illumination that particles are “washed out.” A balance must be established between too much and not enough illumination.

Dark field imaging has been employed in microscopic viewing of specimens. In optical microscopy, dark field imaging involves the illumination of an unstained sample to enhance the contrast with its background. It involves the illumination of a sample with light that is not collected by the objective lens, and thus will not form part of the image. This results is a very dark background with the image under view contrasted as being substantially brighter than the background.

In practice, a stationary sample is positioned on a transparent plate under a microscope. An annular disk is positioned between the microscope's objective and the plate. The disk blocks some light from a light source of the microscope and leaves an outer dog of illumination projected toward the plate. A condenser focuses the light ring toward the sample, which light partially scatters and partially transmits through the sample. The scattered light enters the objective lens while the remainder is not collected. The scattered light alone produces the image of the contents of the sample.

Dark field microscopy produces art image with a dark background. A primary limitation is that the light level in the generated image is very low. This means the sample must be very strongly illuminated, which can cause damage to the sample. Dark field microscopy techniques are almost entirely free of artifacts, due to the nature of the process. However, the interpretation of dark field images must be done with great care, as common dark features of bright field microscopy may be invisible, and vice versa.

While the dark field image may first appear to be a negative of the bright field image, different effects are visible in each. In bright field microscopy, features are visible where either a shadow is cast on the surface by the incident light, or a part of the surface is less reflective, possibly by the presence of pits or scratches. Raised features that are too smooth to cast shadows will not appear in bright field images, hut the light that reflects off the sides of the feature will be visible in the dark field images. Dark field imaging can therefore provide a more complete view of the contents of the sample.

The difficulties associated with dark field imaging in stationary microscopic observations of samples are stronger in the analysis of images of particles moving in a flowing fluid. As a result, the use of dark field imaging has heretofore not been contemplated in flow imaging. Nevertheless, it would be useful to take advantage of the positive characteristics associated with dark field imaging in carrying out particle imaging in a flowing fluid. In particular, but without intent to be limiting, it would be of value to carry out particle imaging in a flowing fluid that provides a more detailed view of the particle than is available with existing flow imaging techniques.

### SUMMARY OF THE INVENTION

It is an object of the present invention to provide such an improved imaging system and method that may he incorporated into, or used with, existing imaging flow cytometers. It is a particular object of the present invention to provide such improved imaging through dark field analysis rather than bright field imaging that has been used exclusively prior to the present invention. These and other objects are achieved with the present invention, which enables better particle imaging than existing flow cytometers.

The particle imaging system of the present invention receives a fluid sample in a flow chamber. The flow chamber is configured to restrict the depth of field of the sample so that dear images may be captured. The particle imaging system includes lighting and photographic equipment described herein for the purpose of creating effective lighting and coordinated photograph taking. The lighting equipment is configured to generate dark field lighting and the photographic equipment is configured to capture images of particles in the fluid sample illuminated in a dark field environment. The FlowCam® fluid imaging system available from Fluid Imaging Technologies, Inc, of Scarborough, Me., modified as described herein for joining with a fluid transport system is suitable for capturing images in the sample fluid using dark field imaging,

The flow chamber of the particle imaging system includes a channel arranged to transport the fluid therethrough at a selectable rate. The particle imaging system also includes a backlighting generator arranged to illuminate the fluid in the flow chamber, an objective arranged to receive incident optical radiation from the flow chamber, a light source arranged to generate light scatter front particles in the fluid, one or more detectors to detect light scatter caused by the particles upon illumination, a signal processor configured to receive signals from the one or more detectors and an image capturing system including means to capture images of particles in the fluid. The backlighting generator may be a very high power (60 Watt) Xenon strobe. The backlighting generator generates a very high intensity flash. The system also includes a computing device to receive signals from the image capturing system. The computer device may be the same computer device used to control fluid transfer. The image capturing system includes a digital camera or an analog camera and a framegrabber. The image capturing system also includes a CCD or a CMOS camera.

In order to maximize light throughput, a lens of a conventional condenser of the particle imaging system has been modified to have light diffuser and a blocking aperture with is numerical aperture of no less than 0.4 when using a microscope lens with a numerical aperture of 0.3. This is far better than a commercially available dark field condenser, such as the dark field condenser available from Olympus, which has a lens with blocking aperture with a numerical aperture of no less than 0.8. The result is much more scattered light collected by the imaging system's objective. This modified condenser lens, in combination with a high intensity strobe light, provides enough light in a short flash to image scattering particles.

The present invention also provides a method for imaging particles in a fluid which is transported through a channel of a flow chamber at a selectable rate and illuminated with a light source so that dark field scatter signals are detected. The method includes as primary steps the steps of acquiring one or more samples from a fluid prior to treatment, passing the sample, which may or may not be diluted, through the flow chamber, illuminating the fluid and capturing images of particles in the sample with a dark field imaging condenser modified as described herein, gathering data regarding characteristics of the particles, such as organisms, in the sample(s), storing that data and optionally analyzing the captured images.

The present invention enables the generation of improved images of particles in a fluid. This and other advantages of the present invention will become more readily apparent upon review of the following detailed description, the accompanying drawings, and the appended claims.

### BRIEF DESCRIPTION OF THE DRAWINGS

FIG. 1 schematically illustrates one embodiment of the system of the present invention for analyzing particles in a fluid.

FIG. 2 depicts several different water-borne organisms with the same types of organism imaged on the left and right sides, with the image on the left captured using prior imaging techniques with bright field detection and the image on the right captured using the modified imaging system of the present invention with dark field detection.

FIG. 3 depicts as sample of a Lyme disease cell culture imaged with dark field detection. Arrows indicate individual Lyme disease cells.

### DETAILED DESCRIPTION OF THE INVENTION

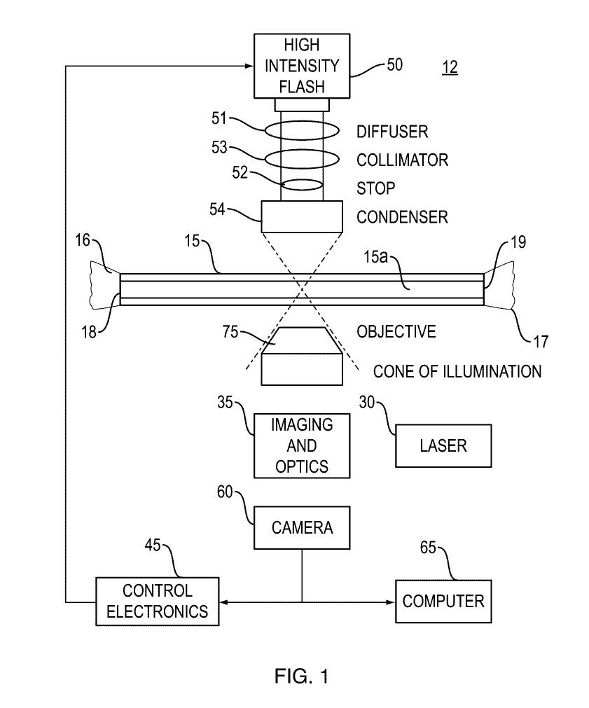

As illustrated in FIG. 1, a particle imaging system 12 of the present invention includes a flow chamber 15 coupled to an inlet conduit 16 and an outlet conduit 17, a light source 30, an imaging and optics system 35, an image detection system 40 including control electronics 45, a backlighting generator 50, in image capturing system 60 and a computing device 65. The combination of these components of the system 12 arranged and configured as described herein enable a user to detect particles in a sample and, specifically, to enhance the image captured by the system.

The flow chamber 15 includes an inlet 18 for receiving the particle-containing sample to be evaluated and an outlet 19 through which the sample passes out of the flow chamber 15 after imaging functions have been performed. A pump may be used to move the fluid into the flow chamber 15. The flow chamber 15 may be fabricated of a material suitable for image capturing, including, for example, but not limited to, transparent microscope glass or glass extrusions that may he ruggedized to withstand abrasive materials. The flow chamber 15 may be formed in a rectangular shape as shown or it may be U-shaped. The flow chamber 15 may be circular or rectangular in shape. The flow chamber 15 defines a channel 15a through which the fluid flows at a predetermined selectable rate. The channel 15a may be of rectangular configuration. The length and width of channel 15a are selected to roughly match the field of view of the imaging optics 35 and may further be sized as a function of the particular fluid to be analyzed. The particle imaging system 12 may include the use of multiple ones of the flow chamber 15, which may be substituted, used in series or used in parallel. The inlet 18 of the flow chamber 15 is connectable to the inlet conduit 16 and the outlet 19 is connectable to the outlet conduit 17.

The backlighting generator 50 is used to generate scatter imaging light which is passed through the diffuser 51, a stop 52, a collimator 53 and a high NA condenser 54 and then in the flow chamber 15, resulting in light scatter by particles located in the fluid. The light source 50 may be a high power xenon strobe such as a Hamamatsu L7685 60 W Xenon flash built in reflector with a E6647 60 W trigger socket, a C6096 60 W power supply, a E6611 cooling jacket and an E7289-02 main discharge capacitor or other suitable light generating means that produces a light of sufficient intensity to backlight the flow chamber 15 and image the passing particles. The imaging and optics system 35 includes a microscope objective 75 to image the particle flow onto the image capturing system 60 and the condenser 54 to focus excitation light from the light source 30, which may be a laser, onto the flow chamber 15. The control electronics 45 may be configured to receive input signals and produce output information compatible with the specific needs of the user of the system 12. An example of a suitable electronics system capable of performing the signal activation and output information associated with the control electronics 45 of the system 12 is the detection electronics described in U.S. Pat. No. 6,115,119, the entire content of which is incorporated herein by reference. Those of ordinary skill in the art will recognize that the specific electronics system described therein may be modified, such as through suitable programming for example, to trigger desired signal activation and/or to manipulate received signals for desired output information.

The backlighting generator 50 may be operated to transmit light periodically, sporadically, or regularly. For example, the light source/laser 30 may excite fluorescence in the flow chamber 15 and a fluorescence detector may be employed on the same side of the flow chamber 15 as the microscope objective 75 to detect fluorescence signals from the sample in flaw chamber 15, such as when a particle passes through the flow chamber 15. When a fluorescence signal occurs, the backlighting generator 50 may be operated to image the passing particle at that time. The control electronics 45 is coupled to the computing device 65. The computing device 65 is programmed to store, the information received from the control electronics 45 and to make calculations and processing decisions based on the information received. The computing device 65 may also be a data collector that transmits the collected data to a different computing component for processing at that component. The computing device 65 is also configured to transmit operational instructions to other devices of the system 12. The computing device 65 may be any sort of computing system suitable for receiving information, running software programs its one or more processors, and producing output of information, including, but not limited to images and data, that may he observed on a user interface. The computing device 65 may be embodied in one device, as shown in FIG. 1. Alternatively, it may comprise a plurality of components that are connected by wire or wirelessly to one another. The computing device 65 may also gather data and transmit that data from a remote location to a location that processes the data. The computing device 65 may he managed remotely or locally. For example, the computing device 65 may be configured with it transmission/reception capability, such as through wireless signal exchanges for data and device management signal exchanges. The signal exchange arrangement may be used to schedule the undertaking of sample fluid analyses and dilution activities. It may also be used to incorporate the system 12 into a bigger processing system.

The control electronics 45 is also coupled, directly or indirectly through the computing device 65 to the backlighting generator 50. In particular, the control electronics 45 and the computing device 65 are arranged to generate a trigger signal to activate the backlighting generator 50 to emit a light flash upon detection of a particle or particles in the flow chamber 15. That is, the trigger signal generated produces a signal to activate the operation of the backlighting generator 50 so that a light flash is generated. The strobe is flashed on one side of the flow chamber 15 for 200 μsec (or less). At the same time, the image capturing system 60 positioned on the opposing side of the flow chamber 15 is activated to capture an instantaneous image of the particles in the fluid suspended in a fixed position when the strobe effect of the high intensity flash occurs. One or more mirrors may be employed to divert light if it is determined that the backlighting is too intensive for effective image capture.

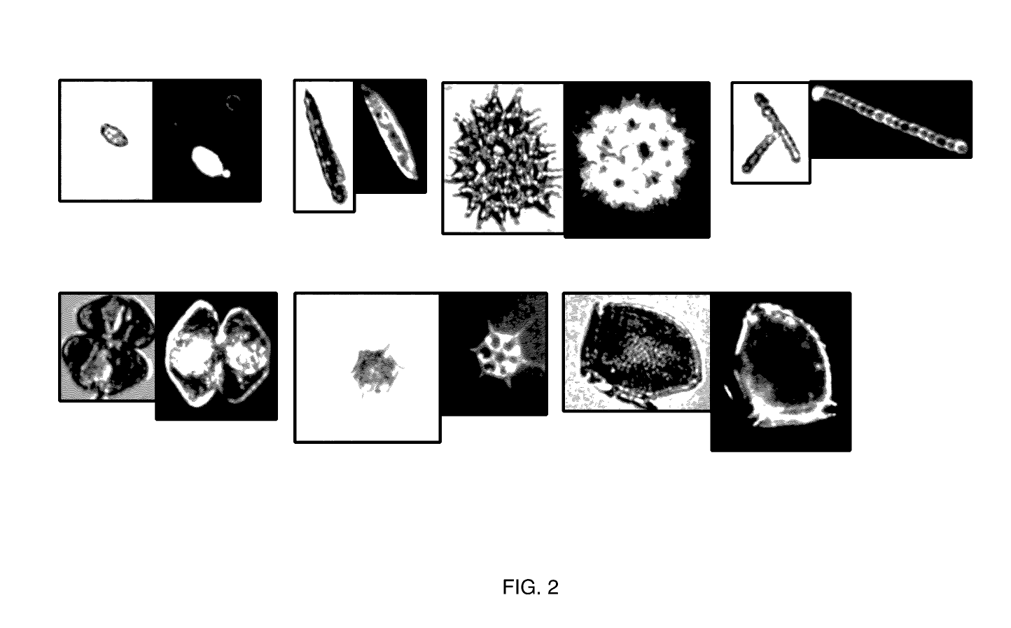

The high NA condenser 54 aids in dark field illumination of that section of the fluid in the flow channel 15a that is to be imaged by focusing the high intensity flash from the backlighting generator 50 to that section. The high NA condenser 54 includes a blocking aperture that should have a numerical aperture of no less than 0.4 when used in combination with a microscope lens of the microscope objective 75 having a numerical aperture of 0.3, resulting it greater scattering of light than has been available. That combination with a high intensity strobe light, such as the 60 Watt high intensity Xenon strobe light available from Hamamatsu, provides enough light in a short flash to image light scattering particles. FIG. 2 represents the difference between using a prior image capture under bright field illumination on the left side, and using the image capture of the present invention under dark field conditions. It is noted that the condenser 54 may he a microscope condenser lens available from Olympus modified with a blocking aperture greater than the imaging objective. For example an objective with a numerical aperture must be used with a blocking aperture with numerical aperture of no less than 0.4.

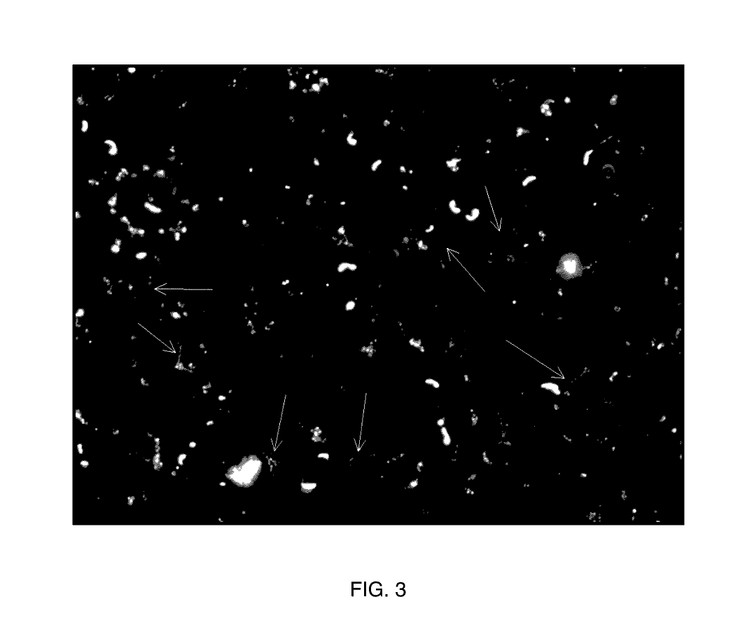

The images represented in FIG. 2 depict different water borne organism images imaged in brightfield and darkfield imaging versions of the flow system. FIG 3 depicts a cell culture of Lyme disease spyrochetes imaged with the darkfield system. The use of dark field light scattering enables much more effective viewing of the particle in the fluid suitable for image capturing. These images are effective representations of other particles that may be of interest to detect and identify including, for example, spirochetes of the type associated with Lyme disease. That is, the particle imaging system 12 of the present invention is an effective means for detecting a microorganism such as a Lyme disease spirochete located in a fluid, such as blood. Of course, other particles or particle features may be detected as well using this dark field illumination technique in combination with a flow cytometry system such as the FlowCam® available from Fluid Imaging Technologies of Scarborough, Me.

The image capturing system 60 is arranged to either retain the captured image, transfer it to the computing device 65, or a combination of the two. The image capturing system 60 includes characteristics of a digital camera or an analog camera with a framegrabber or other means for retaining images. For example, but in no way limiting what this particular component of the system may be, the image capturing system 60 may be, but is not limited to being a CCD firewire, a CCD USB-based camera, or other suitable device, that can be used to capture images and that further preferably includes computing means or means that may be coupled to computing means for the purpose of retaining images and to manipulate those images as desired. The computing device 65 may be programmed to measure the size an shape of the particle captured by the image capturing system 60 and/or store the data for later analysis. The microscope objective 75 focuses the image onto the image capturing system 60. The objective 75 may be a 10× objective, for example. For purposes of the present invention, the microscope lens has a numerical aperture of 0.3.

The images captured by the image capturing system 60 and stored with the computing device 65 may be analyzed and compared to known images of particles. When a trigger is generated (i.e., a light scattering particle is detected), software scans the resulting image, separating the different particle sub-images in it. The area of each particle may be measured by summing the number of pixels in each particle image below a selectable threshold and multiplying the result by the equivalent physical area of a pixel. This computed area of the particle is stored in a spreadsheet-compatible file along with other properties of the particle, e.g., time of particle passage and the location of the particle in the image. The sub-image of each particle is copied from the chamber image and saved with other sub-images in a collage file. Several of these collage files may be generated for each system experiment. A special system file is generated, containing the collage file location of each particle sub-image, particle size and time of particle passage.

The software is written to generate two data review modes: (1) image collage and (2) interactive scattergram. In the image collage mode, the user may review a series of selectable sub-images in a collage file. Reviewing these files allows the user to identify particle types, count particles, or study other features. In interactive scattergram mode, data is presented to the user as a dot-plot; e.g., a graph of particle size. If the user selects a region of the scattergram, images of particles having the characteristics plotted in that region are displayed on a display of the computing device 65, allowing the user to study particle populations and to examine images of particles with specific sizes, such as cells of a specific type. Because a spreadsheet compatible file is generated for each review, the user may also review the data with a spreadsheet program. This information allows the user to readily generate cell counts and scatter and size distribution histograms for each sample. This file also contains the location of each particle in the original image which is used to remove redundant data from particles that have become attached to the flow chamber 15.

One or more embodiments of the invention have been described. Nevertheless, it will be understood that various modifications may he made without departing from the spirit and scope of the invention as described by the following claims. All equivalents are deemed to be within the scope of the claims.

What is claimed is:

1. A system for imaging particles in a fluid using dark field light scattering, the system comprising:
a. a flow chamber, the flow chamber including a channel arranged to transport the fluid therethrough at a selectable rate;
b. a backlighting generated arranged to illuminate the fluid in the flow chamber;
c. an objective with a numerical aperture of 0.3 arranged to receive incident optical radiation from the flow chamber;
d. a light source arranged to generate light scatter from particles;
e. a condenser with a blocking aperture and numerical aperture of no less than 0.4 arranged to produce dark field scattering;
f. one or more detectors to detect light scatter emitted from the particles upon illumination;
g. a signal processor configured to receive signals from the one or more detectors; and
h. an image capturing system including means to capture images of particles in the fluid.

2. The system of claim 1, wherein the backlighting generator is a high power Xenon strobe.

3. The system of claim 1, wherein the backlighting generator generates a high intensity flash.

4. The system of claim 1, wherein the system further includes a computing device to receive signals from the image capturing system.

5. The system of claim 1, wherein the image capturing system includes a computing device.

6. The system of claim 1, wherein the image capturing system includes a digital camera or an analog camera and a framegrabber.

7. The system of claim 1, wherein the image capturing system includes a CCD or a CMOS camera.
